(19) United States
(12) Patent Application Publication
(10) Pub. No.: US 2007/0118732 A1
(43) Pub. Date: May 24, 2007

(54) Method and system for digitally signing electronic documents

(76) Inventor: Dean Joseph Whitmore, Alexandria, VA (US)

Correspondence Address: BIRCH STEWART KOLASCH & BIRCH, PO BOX 747, FALLS CHURCH, VA, 22040-0747, US

(21) Appl. No.: 10/556,588

(22) PCT Filed: May 14, 2004
(86) PCT No.: PCT/US04/15035

§ 371 Date: Jan. 16, 2007

Related U.S. Application Data
(60) Provisional application No. 60/470,441, filed on May 15, 2003.

(51) Int. Cl. H04L 9/00

(52) U.S. Cl. 713/155

(57) ABSTRACT

A method and apparatus for digitally signing an electronic document is provided. Data is inputted into the electronic document by a client. A signing process request is initiated by the client. The signing process request is then transmitted by the client to a server. An input field request, which is generated by the server, is then transmitted to the client. The server is then provided with user authentication credentials in response to the input field request. The user authentication credentials received from the client are verified by the server and the electronic document is digitally signed by the server on the basis of the verification of the user authentication credentials.

This National Phase PCT application claims priority under 35 U.S.C. 119(e) on U.S. Provisional Application No. 60/470,441 filed on May 15, 2003 which is hereby incorporated by reference.

### BACKGROUND OF THE INVENTION

1. Field of the Invention

The present invention relates to a method and system for electronically signing electronic documents or computer data collection applications and then generating a receipt for the signatory.

2. Description of the Background Art

Electronic communications and transactions are ever expanding, particularly due in part because of the growth of the Internet, which is becoming the primary platform for global commerce and communications. Due to this increase in electronic communications and transactions, the demand for security and confidentiality is growing continually in particular for governments and businesses, who demand mechanisms that will not only guarantee the integrity of the information they transmit over the internet, but also provide the same level of trust as paper based transactions.

In non-electronic transactions, a person identified himself or herself to a third party via, for example, a drivers license, ID badges, passport, etc. Also, in a paper based society, a person wrote a letter or filled out a form and signed it, a notary verified that the signature is authentic and belonged to the person signing, the document was placed in an envelope, and could be sent via certified mail. This ensured the recipient that the contents had not been read by anyone else, that the contents of the envelope were intact, that the letter came from the person who claimed to have sent it, and that the person who sent the letter could not easily repudiate having sent it.

Before a business commits its sensitive communications to the Internet, it requires specific assurances. As such, there arises a need for a method to authenticate oneself, ensure that the communication is encrypted so that the receiver is the only one who can decrypt the data file or message, and ensure that the data file or message has not been tampered with and is actually sent by the sender.

These issues have been addressed in the conventional art by applying cryptographic techniques, such as a Public Key Infrastructure (PKI). PKI is an Information Technology infrastructure that allows users of an unsecure network, for example, the Internet, to securely and privately exchange data files and messages through the use of asymmetric public key cryptography that is obtained and shared through a trusted authority in order to mathematically encrypt and decrypt the data files or messages. In sum, PKI provides for the following requirements of a secure network: (1) confidentiality to keep the information private; (2) reliability to prove that the information has not been changed; (3) authentication to prove the identity of the sender; and (4) assurance that the sender cannot deny ownership, e.g., non-repudiation.

Public key cryptography utilizes a public and a private key pair, which are like two halves of a single key. PKI encryption algorithms are designed such that a public key is used to encrypt, e.g., lock, a data file or message and only the complementary private key can decrypt, e.g., unlock, the data file or message. In a PKI system, authorized users receive special encryption software and a pair of keys, one of which is an accessible public key that are published in electronic directories and the other is a private key, which the user must keep secret. Neither of these keys can be used by themselves to decrypt and encrypt the data file or the message.

In the conventional PKI system, users who wish to exchange encrypted data will agree to mutually trust one or more Certificate Authorities (CA) by downloading and installing each trusted authority's root certificate on their computers. They will each obtain their own personal digital certificate from a trusted CA, and install them on their respective computers. A CA is a main component of PKI, it is a trusted third party that is responsible for issuing digital certificates and managing them throughout their lifetime. Specifically, the CA authenticates a user's or organization's identity, much like a notary public verifies the identity of a person in a paper-based transaction.

Digital certificates are electronic files that contain the user's public key and specific identifying information about the user. In other words, the CA certifies that the individual granted the digital certificate is who he or she claims to be, such as a passport office does in assigning an official passport. More specifically, the digital certificate, which is published in on-line directories, typically contains: a user's distinguished name; the issuing CA's distinguished name; the user's public key; the validity period; the certificate's serial number; and the issuing CA's digital signature, which verifies the information in the digital certificate.

Because the users mutually trust the CA, they trust each other's digital certificates, specifically, they trust the public keys contained within their personal digital certificates that have been digitally signed by a trusted CA. The users can then exchange their trusted public keys by sending each other digitally signed files. A digital signature is an electronic identifier that is comparable to a traditional paper-based signature by being unique and verifiable because only the signer can initiate it. The digital signature also ensures that the information contained in a digitally signed data file or message is not altered during transmission.

FIG. 1 is a schematic diagram showing a conventional system of the PKI procedures. If, for example, client A wishes to securely communicate via PKI with client X over a wide area network (WAN) 1, such as the internet, both client A and client X must each have their own digital certificate and private key, which can be installed on each of their computers, stored in an online vault for later retrieval, or provided on a separate hardware token such as a removable disk or a smart card.

Assuming for purposes of explanation that client A has a digital certificate and that client X does not have a digital certificate. Client X must prove to a CA 3 their identity, which typically costs a fee and time expense. Once client X has satisfied their identity to the CA 3, a digital certificate will be issued and will typically be stored on client X's computer. Client X also receives its private key, which is not supposed to be publicly disclosed. Now that both client A and client X each have proven their identity to the CA 3 and have their digital certificates and private keys, they are able to communicate with one another via PKI.

Supposing client A wishes to securely communicate with client X, software on client A's computer creates a digital signature, inserts a time stamp, and encrypts the data file or message to which the digital signature is attached. The software uses client A's private key to create the digital signature and client X's public key to encrypt the message, whereby client A must first retrieve client X's public key either from client X or from an online repository such as CA 3. The encrypted and digitally signed data file or message is then communicated via a local area network (LAN) 5 to a web server 7, which is then routed over the WAN 1 to web server 9 and thus finally to client X.

When client X receives the digitally signed, encrypted data file or message, client X's software utilizes client X's private key to decrypt the message. As only client X's private key can decrypt the data file or message encrypted with its associated public key, the confidentiality of the data file or message is assured. Client X's software then utilizes client A's public key to authenticate client A's digital signature, thereby proving that client A did send the message and that the message was not altered in the transmission.

Conventionally, for client X to authenticate client A's digital signature, client X must also have access to client A's digital certificate and to a certificate revocation list (CRL) 11 for verifying that client A's digital certificate was not revoked at the time that the data file or message was digitally signed. This CRL 11 can be stored and managed by, for example, the CA 3.

A problem associated with the conventional method of using PKI is that every client must have a digital certificate, which, as explained above, typically has a substantial fee and requires that each client identify themselves to a CA via, for example, a passport or driver's license, in order to receive a digital certificate. For a corporation that has several hundred users within its LAN, such an expense amounts to an appreciable sum. In addition, the CRL list must be managed and updated, and with thousands or millions of clients each having their own digital certificate, this becomes a substantial task. Thus, a typical CRL list may not be periodically updated and therefore the validity of issued digital certificates may not be accurately represented.

Furthermore, because time stamping is a critical function in the use of digital certificates, e.g., it is the only means by which the recipient can verify that the certificate was valid during the validity period and not revoked at the time the document was signed, the validity of the time stamp is difficult to validate because the time stamp uses the local computer's clock instead of an independent time stamp authority, for example, the atomic clock in Boulder, Colo. Thus, the reliability of the timestamp itself comes into question because time stamping is the only means by which anyone can substantiate that an electronic document was signed at a specific time. This is of particular concern, for example, in terms of penalties for late filings, such as 11:59 pm on April 15 for Federal taxes.

In addition, the conventional PKI systems do not provide measures to partially verify an e-form layout. For example, many businesses and government agencies provided electronic forms (e-forms), which can be filled out and digitally signed by a user and then transmitted back to the business or government agency. However, these forms may be altered prior to being digitally signed. Thus, there also arises a need to provide for verification that the e-form layout was not altered prior to being digitally signed.

### SUMMARY OF THE INVENTION

It is therefore an object of the present invention to provide a method and system for electronically signing electronic documents or computer data collection applications and then generating a receipt for the signatory.

One example of an electronic document is an electronic form (e-form), which is an electronic representation of a paper form. An example of a computer data collection application is classically referred to as a client in a client/server application system. A client is defined as a local computer with its own operating system. A server is defined as a central computer (e.g., web server) connected to one or more computers that “serves” files to client computers, or processes data at the request of client computers.

Electronic form applications often have three primary components: design software for the form author, filler software for the end user, and server software for the form distributor and/or data collector (the form distributor and data collector may or may not be the same entity, and either may or may not be related to the form author).

Design software is used to create the presentation layer, that is, the user interface or e-form as well as algorithms associated with the e-form and data to be entered into the e-form. The author may design the e-form as a traditional electronic form or integrate elements of hypertext markup language, extensible markup language, portable document format, graphic elements, audible elements, and other objects to achieve the desired user interface. The author may also specify data edits, validation, and other functions such as encryption, glyph generation, printing, saving, e-mail routing information, etc., that govern the behavior of the e-form in the filler application and the interaction with other systems.

While traditional e-forms applications have separate design and filler software, it is also possible to use the same application interface or presentation layer for designing the e-form and filling it out at a later date. Examples could include a word processing application or a spreadsheet.

Filler software allows users to view and interact with the e-forms created using the design software. User interactions include filling out the e-form electronically, saving the e-form to a local computer, printing the e-form, submitting the e-form, and similar functions depending on the algorithms and functions associated with the e-form by the author.

The software application used for entering data may reside on the end-user's local computer (e.g., hardrive, RAM, etc.), including e-form filler clients, browsers, word processors, etc. Once the user enters data into the application interface, e.g., the presentation layer, the data and the presentation layer (together commonly thought of as an electronic document or e-form) or the data alone can be submitted to a server computer for further processing.

Server software allows form distributors and data collectors to process forms (e-forms and other electronic documents) automatically. The server software enables the form distributor to pre-fill forms with data from a database or other data-store and to distribute the pre-filled forms and other electronic documents to end-users electronically, e.g., via email, work flow, or other methods. Optionally, the distributor may encrypt the pre-filled data, or subsets of the pre-filled data, prior to distributing the e-forms.

Server software also enables data collectors to process incoming e-forms electronically and automatically. An example of such processing would be to receive the incoming e-form, identify the form, authenticate the form, decrypt the form, extract the data from the form, and write the data to a database. Other processing functions, currently known or unknown, could be associated with other processing scenarios.

Prior to the present invention, when electronic documents and e-forms were resident on a local computer, the only secure and authenticated method of digitally signing these documents was to use a X.509-based digital certificate, or a biometric peripheral installed on the user's local computer. The purpose of digitally signing electronic documents and e-forms was to both authenticate the identity of the person (signer) who signed the form, and prevent non-repudiation of the signed documents—that is, the signer cannot later claim that he/she had no knowledge of the document or its submission).

In a further embodiment of the present invention users are able to digitally sign electronic documents and e-forms without requiring digital certificates on the local computer. In addition, organizations, such as form distributors or data collectors, can authenticate users without issuing digital certificates or relying on third party certificate authorities, i.e., Public Key Infrastructures. Lastly, users can receive an authenticated, time-stamped receipt of their electronic document submission.

The invention utilizes a combination of end user authentication credentials, such as login identification and digital certificate technology, e.g., X.509 digital certificate technology, to sign the form by the signatory. The electronic document is then digitally signed using PKI technology by a server computer and presented to the signatory on a local computer so that the signatory has an electronic receipt of their signed document, which can be presented to, recognized, and trusted by the person or authority accepting the signed document. This method and system eliminates the need for more costly public key infrastructure and digital certificate issuance and revocation technology and techniques.

The present invention assumes an organization (business, government agency, or other entity; herein the “Data Collector”) has a server computer or website wherein users can log into this site using traditional login techniques which can be entered from any standard computer keyboard such as User ID's, passwords, PIN numbers, etc. Such login ID/Password credentials are standard for logging into a local area network or non-public areas of a website.

The present invention also assumes an organization has installed a digital certificate and its associated private key on a server. Such digital certificates are commonly used for Secure Socket Layer (SSL) transactions between a web browser and a server to seamlessly encrypt data that is being communicated over the Internet between desktop users (clients) and remote servers.

The person designing or creating a form (typically referred to as the “form author”) creates an e-form or other electronic document and embeds certain logic into it, such as data edits, validation, etc. In addition, the form author specifies an existing server using a Uniform Resource Locator (URL), and other additional parameters that specify what data is to be transmitted to the server, and the type of request.

The form author can then lock the form layout using an application's native encryption, or sign the form layout with a digital certificate. This action of locking the form with a digital certificate embeds the data collector's public key directly into the e-form or electronic document. The e-form or electronic document is then posted to a website, emailed to a user, exchanged on tape or disk media, or otherwise made available to an end-user for loading on a local computer.

Where the document is so made available, end users can then download this e-form or document directly from a website, receive it via email, or otherwise store it on their local computer for present or later use. When a user opens and displays the electronic document or e-form he/she can enter data or otherwise modify the document, or simply sign it.

Once the form is complete and the user is ready to digitally sign the e-form, the user can press a “sign” button or other user interface object. When the “sign” button or other user interface object is pressed, the client application (in this example, e-forms Filler software) automatically contacts the server specified by the URL embedded into the electronic document by the e-form author. This contact can be accomplished using a compressed, encrypted message from the client computer, to the server. Encryption can be accomplished using the public key embedded into the e-form or electronic document by the form author.

The server receives the compressed, encrypted message, validates and decrypts it using the local private key. This initial message string requests from the server instructions for a user interface element for displaying on the client computer for collecting user authentication credentials. This user interface element can be presented as an HTML (hypertext markup language) dialog or other appropriate user interface.

The server then returns an encrypted message to the client computer, containing instructions for displaying a user interface appropriate for collecting the user's authentication credentials, such as a login screen displayed in an HTML browser window. In addition to this, the server may send a token (nonce) to the client application with the specific instruction that this token is to be transmitted back. The token is generated in such a way that the possibility of having two identical tokens in a reasonable amount of time is extremely low.

The client application validates, decrypts and displays the server message in the client application.

The user can then enter his/her respective login ID/Password and press <Enter>, “Sign”, or some visual representation therein. Other user authentication credentials may also be supplied as appropriate.

The client application then creates a compressed, encrypted message stream having the ID/Password, the form packed and encoded, and the optional token or nonce and transmits this stream to the server.

The server receives the compressed, encrypted message stream and then validates, decrypts and passes the ID/Password combination to an authentication server (if different). In addition, the server can take advantage of Lightweight Directory Access Protocol (LDAP) for accessing online directory services over a TCP/IP network protocol, and can be used to access standalone LDAP directory services or other directory services supporting, for example, the X.509 standard. If there was a token or nonce transmitted by the server, the server will verify it as well.

If the ID/Password combination is invalid, the server returns an encrypted message stream to that effect to the client application, and the client application can be either restarted or terminated.

If the ID/Password combination and the optional token or nonce are validated, the server signs the enclosed form with the server's digital certificate and private key using a standard protocol for signing electronic documents, such as PKCS #7 (Public-Key Cryptography Standard, Number 7) or CMS (Cryptographic Message Syntax). At the time the document is signed, information uniquely identifying the user and optionally other transaction details are entered onto the e-form using fields that were created for that purpose by the form author. Examples of such data can be the user's ID or name, a server time-stamp, or a transaction number. The now signed e-form is then compressed, encrypted, and transmitted back to the client application for display.

The client application then replaces the unsigned document with the server-signed document and displays it in the local client application. The user can now examine the digital signature, save the document locally, send it to other users for review, archive it, or perform any other actions as permitted by the local client application and the signed document.

The above process is relatively transparent to the user; however, depending on the speed of the network connection and the size of the form, the user may see a server transmission progress indicator.

This method and process for signing documents on local computers allows for the following examples discussed below.

Organizations no longer need to distribute digital certificates to users, or rely on third party certificate authorities to distribute certificates in order to effect digitally signed documents.

Organizations only need a single digital certificate installed on the server to produce digitally signed authenticated documents and provide official signed receipts to document submitters.

Organizations can use their existing login ID/Password infrastructure and optional LDAP or other connectivity for signing electronic documents and e-forms even when these documents exist on a local computer.

When the document is signed using the server-based digital certificate and transparently submitted back to the user's local machine, it contains a digital certificate from the signing server together with the server's timestamp. This digital signature can be used by the user as proof of both receipt and time of receipt and proof of authentication of user. Rather than rely on a local computer's clock (which may or may not be accurate or tampered with) as proof of the time that a document was submitted, the user now has a document signed and time-stamped by the data collector's server, which therefore cannot be disputed by the data collector.

Because the message stream between client and server is automatically compressed and encrypted, SSL can be used but is not required to effect secure transmissions across the Internet.

End users can sign electronic forms or other electronic documents without the requirement to apply for, or maintain a personal digital certificate on local computers.

Organizations can easily revoke ID/Password credentials or other authentication credentials since this method and system utilizes their existing technology infrastructure for end user (signatory) authentication. In this vein, organizations do not need to rely on third party Certificate Revocation Lists nor so they have to support the costs associated with setting up and maintaining a revocation infrastructure for X.509 digital certificates.

Signatory authentication is not limited to utilizing User-ID/Password credentials. This method and system can utilize multiple authentication credentials, including: User-ID/Password, PKI certificates, physical tokens, Q&A databases, shared secrets, biometric devices, and generally any user authentication scheme where the means of authentication can be transmitted electronically from one computer system to another.

The authentication of the signatory can be performed by the recipient organization or by an independent third party, such as a Certificate Authority.

This method and system of signing as described above is an online procedure requiring active participation from a server to the client. The authentication of the signatory and signing of the document by the server is accomplished in real time.

The security of this method and system is substantially identical to that of an X.509 digital certificate infrastructure.

Organizations that want to offer authentication services (as or like a Certificate Authority—CA) can now do so without the significant expense of building a PKI CA infrastructure, but instead can simply use their existing database and single digital certificate at minimal or insignificant expense.

For clarity, the description above spoke of a person or persons signing electronic documents. However, this invention can be used in an automated process as well without human intervention. For example, two or more servers in different organizations may use this method for data exchange, and for proof of transactions.

While the invention describes electronic forms as one type of electronic file, the invention can be used with all types of stored electronic files.

Furthermore, the invention can also incorporate the possibility of the user having a private key (stored on his local machine or on a hardware token, like a secure card). A private key is an addition to this system that provides stronger authentication, and such a mixed system would keep all other benefits (the time-stamping, centralized user rights management, etc).

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic diagram showing a conventional system of PKI procedures;

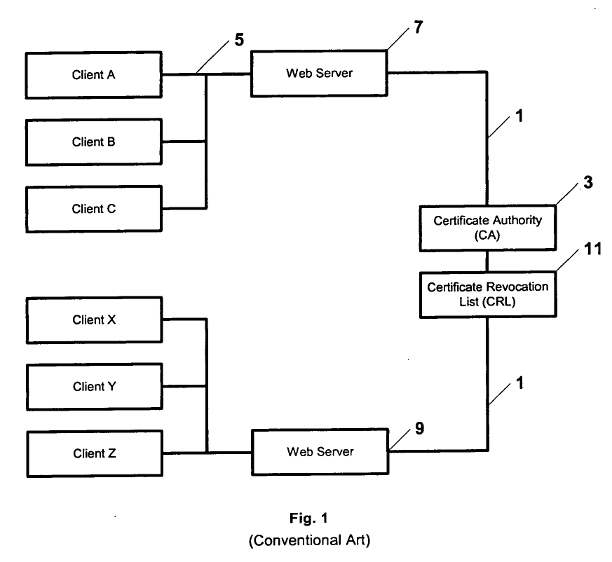

FIG. 2 is a schematic diagram of the system of the present invention according to a preferred embodiment;

FIG. 3 is a flow chart depicting the creation and digitally signing of an electronic form layout;

FIG. 4 is a flow chart depicting a digital signing process between a client and a server according to an embodiment of the present invention; and

FIG. 5 is a flow chart depicting a digital signing process between a client and a server according to an alternate embodiment of the present invention.

### DETAILED DESCRIPTION

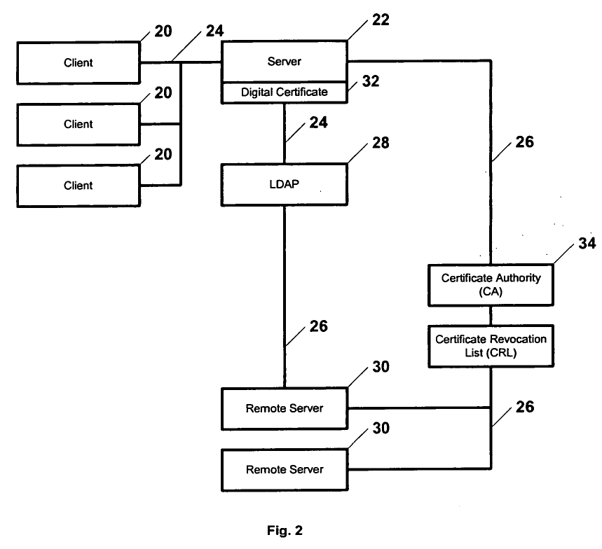

FIG. 2 shows a block diagram of a system for signing electronic documents or computer data collection applications, authenticating a signatory, and generating a receipt for the signatory, according to a preferred embodiment of the present invention.

A plurality of clients 20 are connected to a server 22 over a LAN 24. The server 22 is connected to a WAN 26, such as the Internet. The server 22 can be further connected to an authentication service/directory such as LDAP 28. The LDAP 28 can also be connected to a plurality of additional remote web servers 30 via LAN 24 or WAN 26.

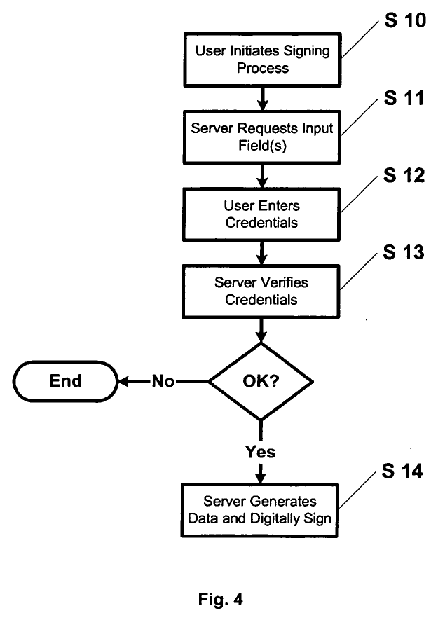

Within the LAN network 24, preferably, only the server 22 has a digital certificate stored therein, whereby the clients 20 utilize the server's 22 digital certificate in order to digitally sign an e-form, as will be discussed further herein below, with reference to FIG. 4. Because only the server 22 has a digital certificate, the individual clients 20 are not required to each receive a digital certificate from a Certificate Authority (CA) 34. Thus, an organization is able to significantly reduce costs associated with signing secured documents and obtaining digital certificates.

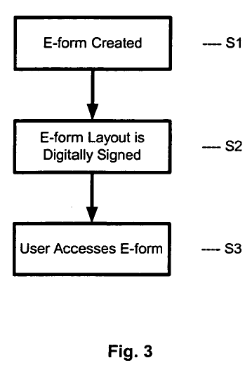

Referring to FIG. 3, an e-form is created in step S1 by an author (not shown). When the e-form is completed, the author can lock the e-form in step S2. The e-form can be locked according to the digital signing procedures outlined above or can be locked by measures provided to the author by authoring software, thereby ensuring that the layout and content created by the author of the e-form is secured. In other words, a subsequent user of the e-form is not able to modify the form by removing substantive and necessary language or modifying the layout to an undesirable form, without knowledge of subsequent receivers of the e-form because the digital signature ensures that the layout or content is not altered that was created by the author.

When the client 20 finishes entering data into the e-form, the client 20 initiates a signing process in step S10, as shown in FIG. 4. The client 20 can initiate the signing process by clicking an action button, a hyperlink, or doing any other action that results in a command or a command list being executed, thereby indicating to the server 22 that the client 20 intends to sign. Such an action button, hyperlink, etc. can be provided within a display screen of the form filler software, which, as stated above, can be executed by the client 20. The initiating of the signing process by the client 20 can also establish a secure transmission channel between the client 20 and the server 22 by an encrypted and/or compressed transmission protocol, for example, SSL (Secure Socket Layer). This secure transmission channel can also be initiated by the server 22 in response to the client's 20 initiation of the signing process or at any other time during the signing process.

The server 22 then provides an input field, which can be in the form of a dialog box, to the client 20 in step S11 thereby requesting authorization. The client 20 enters their credentials in step S12, which can be, for example, a username and a password. Alternatively, the server 22 can provide the client 20 with multiple dialog boxes, each having input fields and requiring a response from the client 20. For example, when the client 20 initiates the signing process in step S10, the server 22 can provide a first dialog box to the client 20 requesting that the client 20, for example, acknowledges that the signing process will begin. After the client 20 acknowledges the server request, via, for example, an action button in the first dialog box, the server 22 receives the acknowledgment from the client 20 and then provides the client with a second dialog box requesting that the client 20 enter a username and a password, as described above. Moreover, the sequence and type of dialog boxes provided by the server can be changed at any time without necessitating any changes to the form itself, e.g., one user may be requested for a user ID and password and another user may get a request for their mother's maiden name.

When the client 20 enters an action command to send the client's 20 credentials to the server 22, the e-form that was modified by the client 20 is supplied to the server 22 concurrently with the client's 20 credentials. Alternatively, a hash of the e-form or of a portion of the e-form that is to be signed is sent to the server 22 concurrently with the client's 20 credentials. Additionally, the client 20 can provide signing instructions, which indicate which areas of the electronic form to sign, to the server 22.

The server 22, upon receipt of both the client's 20 credentials and the modified e-form, first verifies the credentials in step S13. In other words, the server 22 compares the client's 20 credentials to, for example, the LDAP repository 28 and/or any known password authentication scheme, such as a comparison of a hash function of the password to a previously stored hash of a password. If the client 20 is successfully verified, the server 22 may add additional data to the e-form that identifies the client 20 as well as data that is relevant to the transaction, such as a time stamp, a transaction number, etc. This data can be integrated into the e-form itself thereby altering the e-form, can be provided into authenticated signature attributes, which are not part of the e-form data, or a combination thereof can also be used. If the client 20 is not successfully verified, the signing process can either end or restart at any point.

Thereafter, the resulted form is signed by the server 22 in step S14, utilizing, for example, the server's 22 unique digital certificate, and can be transmitted back to the client 20, transmitted to an alternate client for further inputs, or forwarded to another server for further processing.

If the server 22 receives the client's 20 credentials and the hash of the e-form, in contrast to the modified e-form, the server 22 then constructs and sends back to the client 20 a detached signature, which is then combined by the client 20 with the original e-form that was created by the author, as explained above, in order to create a signed document.

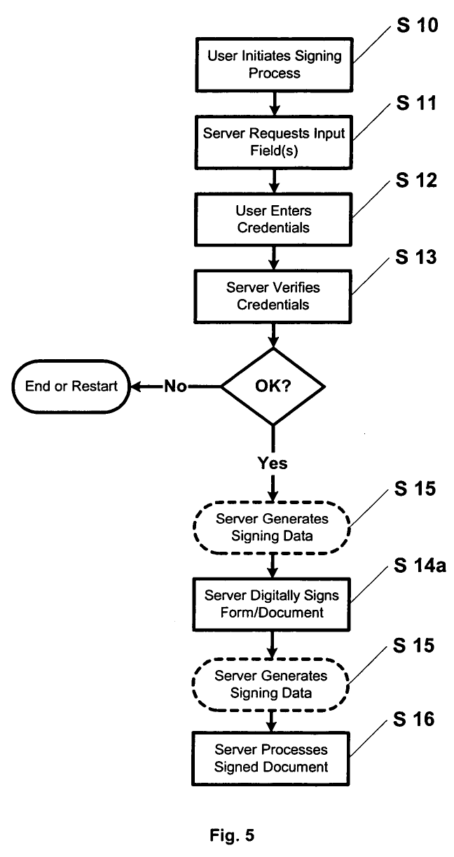

FIG. 5 is a flow chart depicting a digital signing process between a client 20 and a server 22 according to an alternate embodiment of the present invention. Steps S10 to S13 of FIG. 5 are similar to steps S10 to S13 of FIG. 4, which have been described herein above. Steps S14a to S16 describe an alternate signing ceremony in comparison to FIG. 4.

During step S15, the server 22 generates signing data, which can be performed before or after the server 20 digitally signs the e-form in step S14a. If the server 22 generates/retrieves data such as the user's name, user ID, the timestamp or similar data, which is to be entered into pre-existing fields on the form, then this is performed prior to the server signing the e-form in step S14a. If the server 22 signs the e-form in step S14a prior to generating data, then this data can be attached to the signature into authenticated signature attributes after the digital signing procedure in step S14a. Thereafter, the server 22 then processes the signed document in step S16 by transmitting the digitally signed e-form to the client 20, to an alternate client for further inputs, or to another server for further processing. This further processing can include, for example, the application of additional signatures without requiring additional data input, i.e., as in an approval process for a purchase order.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method of digitally signing an electronic document, the method comprising:
inputting data into the electronic document by a client;
initiating a signing process request by the client;
transmitting the signing process request by the client to a server;
transmitting an input field request, which is generated by the server, to the client;
providing the server with user authentication credentials in response to the input field request;
verifying, by the server, the user authentication credentials received from the client; and
digitally signing the electronic document by the server on the basis of the verification of the user authentication credentials.

2. The method according to claim 1, wherein the electronic document is an electronic form.

3. The method according to claim 2, wherein an original layout and content of the electronic form has been digitally signed.

4. The method according to claim 1, wherein the client initiates the signing process by actuating an action button, a hyperlink, or other actuating method.

5. The method according to claim 4, wherein the action button, hyperlink, or other actuating method is provided in a display screen of an electronic form filler software, which is executed by the client.

6. The method according to claim 1, wherein a plurality of input field requests are generated by the server and transmitted to the client.

7. The method according to claim 6, wherein the plurality of input field requests are transmitted to the client individually, each of the plurality of input field requests requiring an input response from the client.

8. The method according to claim 6, wherein the plurality of input field requests are transmitted to the client simultaneously.

9. The method according to claim 1, wherein the user authentication credentials are a user login and a password.

10. The method according to claim 1, wherein the user authentication credentials are verified by the server by comparing the user authentication credentials with stored user authentication credentials.

11. The method according to claim 10, wherein the stored user authentication credentials are stored in a database that is connected to the server by a network.

12. The method according to claim 1, further comprising the step of transmitting the electronic document, which contains the inputted data, concurrently with the user authentication credentials from the client to the server.

13. The method according to claim 1, further comprising the step of transmitting a hash of the electronic document or a hash of a portion of the electronic document concurrently with the user authentication credentials from the client to the server.

14. The method according to claim 1, further comprising the step of generating and/or retrieving additional data by the server.

15. The method according to claim 14, wherein the additional data includes a client identifier, a time-stamp, or a transaction number.

16. The method according to claim 14, wherein the additional data is added to the electronic document prior to the electronic document being digitally signed by the server.

17. The method according to claim 14, wherein the additional data is added to into authenticated signature attributes after the electronic document is digitally signed.

18. The method according to claim 1, wherein the server digitally signs the electronic document utilizing a Public Key Infrastructure.

19. The method according to claim 1, wherein, for further processing, the digitally signed electronic document is transmitted back to the client, transmitted to a remote server, or transmitted to a second client.

20. The method according to claim 19, wherein the further processing includes additional data input, data extraction, archiving, reviewing, or other functions.

21. The method according to claim 1, wherein the client and the server are connected to each other by a network.

22. The method according to claim 1, wherein the client is provided with a receipt after the electronic document is digitally signed.

23. The method according to claim 22, wherein the receipt includes the digitally signed electronic document.

24. The method according to claim 1, wherein the method of digitally signing the electronic document is performed on a system to system basis.

25. The method according to claim 1, wherein the input field request can be changed independently of the electronic document.

26. The method according to claim 1, wherein the verification of the user authentication credentials and the digitally singing of the electronic document is performed in real time.

27. A method of digitally signing an electronic form, the method comprising:
inputting data into the electronic form by a client;
initiating a signing process upon completion of inputting the data into the electronic form by a user input;
transmitting an input field request, which is generated by the server, to the client, the server and the client being connected to each other by a network;
transmitting to the server user authentication credentials and the electronic form containing the inputted data in response to the input field request and in response to the user input;
verifying, by the server, the user authentication credentials received from the client; and
digitally signing the electronic form by the server on the basis of the verification of the user authentication credentials, the digital signing utilizing a public key infrastructure.

28. A system for digitally signing an electronic document, the system comprising:
means for inputting data into the electronic document by a client;
means for initiating a signing process request by the client;
means for transmitting the signing process request by the client to a server;
means for transmitting an input field request, which is generated by the server, to the client;
means for providing the server with user authentication credentials in response to the input field request;
means for verifying, by the server, the user authentication credentials received from the client; and
means for digitally signing the electronic document by the server on the basis of the verification of the user authentication credentials.
